(19) United States
(12) Patent Application Publication
(10) Pub. No.: US 2013/0108163 A1
(43) Pub. Date: May 2, 2013

(54) IMAGE EVALUATION APPARATUS, IMAGE EVALUATION METHOD, AND PROGRAM

(71) Applicant: Sony Corporation, Tokyo (JP)

(72) Inventors: Takeyuki Fujii, Tokyo (JP); Masakazu Kawada, Kanagawa (JP); Shoichi Suzuki, Kanagawa (JP); Masaaki Sato, Kanagawa (JP); Shinichiro Saito, Kanagawa (JP)

(73) Assignee: SONY CORPORATION, Tokyo (JP)

(21) Appl. No.: 13/657,437

(22) Filed: Oct. 22, 2012

(30) Foreign Application Priority Data
Oct. 28, 2011 (JP) 2011-237851

(51) Int. Cl. G06K 9/46

(52) U.S. Cl. 382/192

(57) ABSTRACT

An image evaluation apparatus includes: a holding section configured to hold a plurality of visual characteristic functions in advance; an image-feature-quantity extraction section configured to extract an image feature quantity of an image to be evaluated; a frequency-characteristic extraction section configured to extract a frequency characteristic of the image to be evaluated; a selection section configured to select a visual characteristic function in accordance with the image feature quantity extracted by the image-feature-quantity extraction section from the plurality of visual characteristic functions of the holding section; a correction section configured to correct the frequency characteristic extracted by the frequency-characteristic extraction section using the visual characteristic function selected by the selection section; and an image-evaluation-value acquisition section configured to acquire an image evaluation value on the basis of frequency characteristic information corrected by the correction section.

### BACKGROUND

The present disclosure relates to an image evaluation apparatus that performs image evaluation of an image obtained from an image input device, such as a digital camera, etc. The present disclosure also relates to an image evaluation method, and a program.

In image quality evaluation of an image obtained from an image input device, it is noted that spatial frequency components greatly affect appearance. In a related art, a function related to a visual characteristic, which is called a CSF (Contrast Sensitivity Function, VTF) is used (refer to Japanese Unexamined Patent Application Publication No. 9-284429).

An image evaluation apparatus disclosed in Japanese Unexamined Patent Application Publication No. 9-284429 converts image information which is displayed on an image display device using an image to be evaluated, which is input from an image input device, into spatial frequency distribution information.

The image evaluation apparatus performs filtering processing on the spatial frequency distribution information obtained by the conversion using a function representing a spatial frequency characteristic of a human visual system in accordance with observation parameters, and then calculates an image evaluation value from image information obtained by performing inverse transformation.

The observation parameters are parameters regarding an observation distance, a screen average luminance, and a luminance of a screen peripheral part.

### SUMMARY

Incidentally, a spatial frequency characteristic of a human visual system greatly varies with a contrast (image feature quantity) of an image. However, the above-described image evaluation apparatus gives no consideration to that point. In a related art, only “observation parameters” are taken into consideration.

Accordingly, in the above-described image evaluation apparatus, it is difficult to perform evaluation with optimum visual characteristics, and to perform image quality evaluation that matches subjective evaluation by a human visual sense correctly with high reliability.

In this regard, a fact that a visual characteristic has dependence on contrast is described in “Image and Visual Information Science” (The Institute of Image Information and Television Engineers), p. 74 as follows:

“MTF in a state of discrimination limit (threshold value) in low contrast generally indicates a band-pass characteristic having a local maximal sensitivity at a specific frequency band, and MTF in a state of suprathreshold demanding appearance contrast in high contrast changes to a low-pass characteristic.”

It is desirable to provide an image evaluation apparatus capable of performing evaluation using optimum visual characteristics and performing image quality evaluation that matches subjective evaluation by a human visual sense correctly with high reliability. It is also desirable to provide an image evaluation method, and a program.

According to an embodiment of the present disclosure, there is provided an image evaluation apparatus including: a holding section configured to hold a plurality of visual characteristic functions in advance; an image-feature-quantity extraction section configured to extract an image feature quantity of an image to be evaluated; a frequency-characteristic extraction section configured to extract a frequency characteristic of the image to be evaluated; a selection section configured to select a visual characteristic function in accordance with the image feature quantity extracted by the image-feature-quantity extraction section from the plurality of visual characteristic functions of the holding section; a correction section configured to correct the frequency characteristic extracted by the frequency-characteristic extraction section using the visual characteristic function selected by the selection section; and an image-evaluation-value acquisition section configured to acquire an image evaluation value on the basis of frequency characteristic information corrected by the correction section.

According to another embodiment of the present disclosure, there is provided a method of evaluating an image, the method including: extracting an image feature quantity of an image to be evaluated; extracting a frequency characteristic of the image to be evaluated; selecting a visual characteristic function in accordance with the image feature quantity extracted by the extracting an image feature quantity from a plurality of visual characteristic functions given in advance; correcting the frequency characteristic extracted by the extracting a frequency characteristic using the visual characteristic function selected by the selecting; and acquiring an image evaluation value on the basis of frequency characteristic information corrected by the correcting.

According to still another embodiment of the present disclosure, there is provided a program for causing a computer to perform image evaluation processing including: extracting an image feature quantity of an image to be evaluated; extracting a frequency characteristic of the image to be evaluated; selecting a visual characteristic function in accordance with the image feature quantity extracted by the extracting an image feature quantity from a plurality of visual characteristic functions given in advance; correcting the frequency characteristic extracted by the extracting a frequency characteristic using the visual characteristic function selected by the selecting; and acquiring an image evaluation value on the basis of frequency characteristic information corrected by the correcting.

By the present disclosure, it is possible to perform evaluation using optimum visual characteristics and to perform image quality evaluation that matches subjective evaluation by a human visual sense correctly with high reliability.

### BRIEF DESCRIPTION OF THE DRAWINGS

FIG. 1 is a block diagram schematically illustrating an overall configuration of an image evaluation system to which an image evaluation apparatus according to the present embodiment is employed;

FIGS. 2A, 2B, and 2C are diagrams illustrating spatial frequency characteristics of a visual system;

FIG. 3 is a diagram for explaining a visual characteristic that is applied to an image evaluation apparatus according to the present embodiment;

FIG. 4 is a block diagram illustrating an example of a configuration of an image-evaluation-value processing section of the image evaluation apparatus according to the present embodiment;

FIG. 5 is a diagram illustrating visual spatial frequency characteristics with respect to contrast;

FIG. 6 is a diagram for explaining a method of determining an optimum visual characteristic from power spectrum having been subjected to frequency transformation;

FIG. 7 is a flowchart illustrating a series of operation of the image evaluation apparatus according to the present embodiment;

FIG. 8 is a diagram schematically illustrating an image evaluation system according to the present embodiment in the case of performing noise evaluation;

FIG. 9 is a first diagram illustrating an image evaluation system in the case of performing resolution evaluation;

FIG. 10 is a second diagram illustrating an image evaluation system in the case of performing resolution evaluation;

FIGS. 11A and 113 are diagrams illustrating an example in which a visual characteristic function illustrated in FIG. 5 is selected by comparing a threshold value and an image feature quantity;

FIG. 12 is a diagram for explaining a first selection method of selecting a visual characteristic function illustrated in FIG. 5 by comparing a threshold value and an image feature quantity;

FIG. 13 is a diagram illustrating a ratio calculation graph for generating a visual characteristic function;

FIGS. 14A, 14B, 14C, and 14D are diagrams for specifically explaining a method of generating an optimum function for each frequency component illustrated in FIG. 6;

FIG. 15 is a diagram illustrating an example in which the visual characteristic function in the resolution evaluation using the chart in FIG. 10 is selected by comparing a threshold value and an image feature quantity;

FIG. 16 is a first method of determining a range of an image feature quantity from the histogram of the image to be evaluated in FIG. 15; and

FIG. 17 is a second method of determining a range of an image feature quantity from the histogram of the image to be evaluated in FIG. 15.

### DETAILED DESCRIPTION OF EMBODIMENTS

In the following, descriptions will be given of embodiments according to the present disclosure with reference to the drawings.

In this regard, the descriptions will be given in the following order.

1. Overview of overall configuration of image evaluation system
2. Configuration of image evaluation apparatus

3. Method of selecting a visual characteristic function by threshold value

1. Overview of Overall Configuration of Image Evaluation System

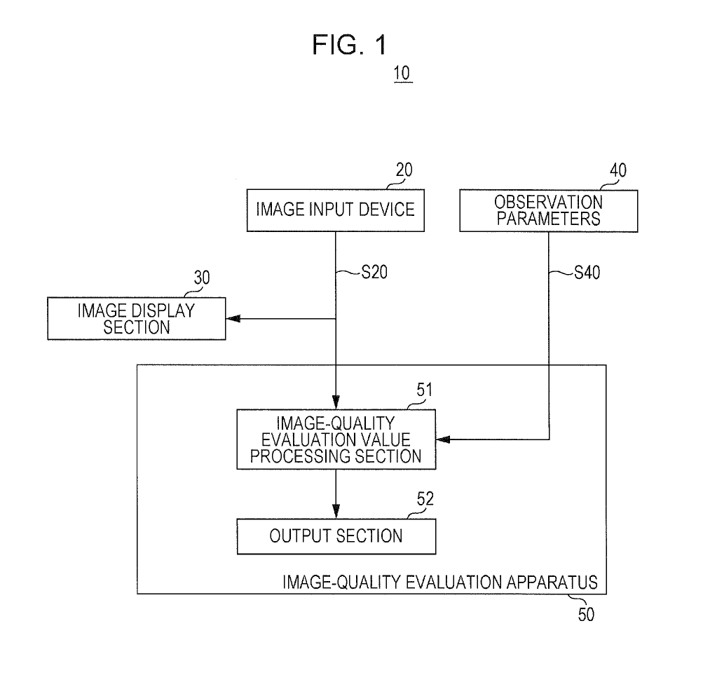

FIG. 1 is a block diagram schematically illustrating an overall configuration of an image evaluation system to which an image evaluation apparatus according to the present embodiment is employed.

The image evaluation system 10 includes an image input device 20, an image display section 30, an observation parameter input section 40, and an image evaluation apparatus 50.

In the image evaluation system 10, an image to be evaluated S20, which is a digital image or a chart image, etc., that is captured by an image input device 20, such as a digital camera, etc., is input into the image evaluation apparatus 50, and is displayed on the image display section 30, such as a liquid crystal display unit (LCD), etc.

The image evaluation apparatus 50 receives input of the image to be evaluated S20 obtained by the image input device 20, which is displayed on the image display section 30, and observation parameters S40 including an observation condition that is input from the input section 40.

The image evaluation apparatus 50 calculates an image quality evaluation value of the image to be evaluated from the given observation condition.

Here, the observation parameters include parameters on an observation distance (visual distance), a screen average luminance, and a luminance of a screen peripheral part. For example, the observation parameters include an observation condition, such as a distance from an observer to an image display section, a resolution by the image display section (for example, 96 dpi), etc.

### 2. Configuration of Image Evaluation Apparatus

The mage evaluation apparatus 50 includes an image-quality (image) evaluation value processing section 51, and an output section 52.

As described later in detail, the image-quality evaluation value processing section 51 extracts an image feature quantity (for example, contrast) of an observation image, and a frequency characteristic of an image to be evaluated.

The image-quality (image) evaluation value processing section 51 selects a visual characteristic function in accordance with an image feature quantity extracted from a plurality of visual characteristic (spatial frequency and sensitivity) functions that are given in advance. The image-quality (image) evaluation value processing section 51 corrects the frequency characteristic extracted from the selected visual characteristic function, and obtains an image evaluation value on the basis of the corrected frequency characteristic information.

The image feature quantity includes a contrast of an image to be evaluated, luminance information of a background image, for example, an average luminance of a background image, or a frequency analysis result (power spectrum) of an image to be evaluated, etc.

The image evaluation apparatus 50 according to the present embodiment selects a visual characteristic function in accordance with an image feature quantity of the image to be evaluated from a plurality of visual characteristic functions, and performs correction on the frequency characteristic using the selected visual characteristic.

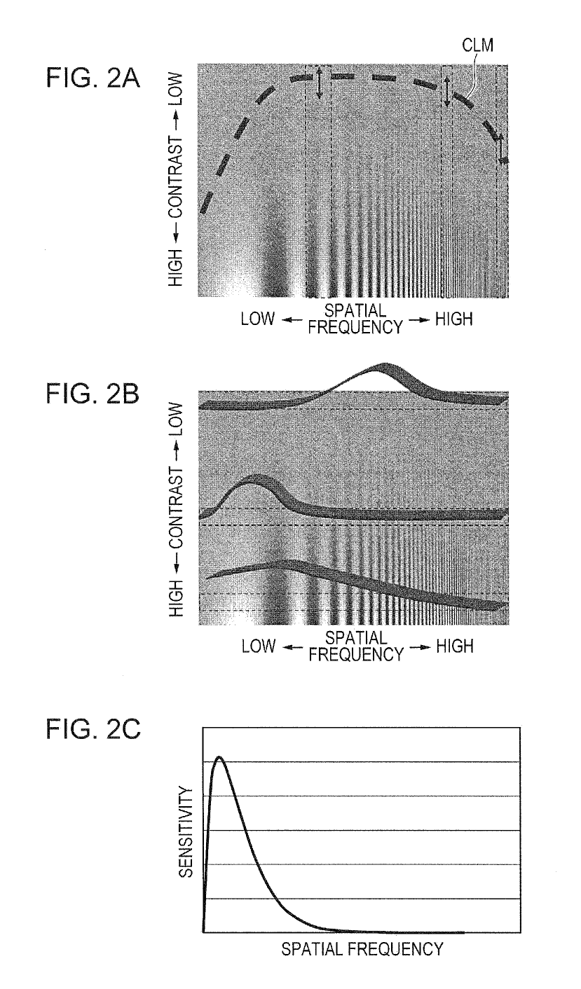

FIGS. 2A, 2B, and 2C are diagrams illustrating spatial frequency characteristics of a visual system.

FIG. 2A is a diagram for explaining a method of obtaining a spatial frequency of a general visual system.

FIG. 2B is a diagram for explaining a method of obtaining a spatial frequency of a visual system according to the present embodiment.

FIG. 2C is a diagram illustrating a graph of CSF (=VTF) obtained from the contrast detection limit (limit value) CLM in FIG. 2A.

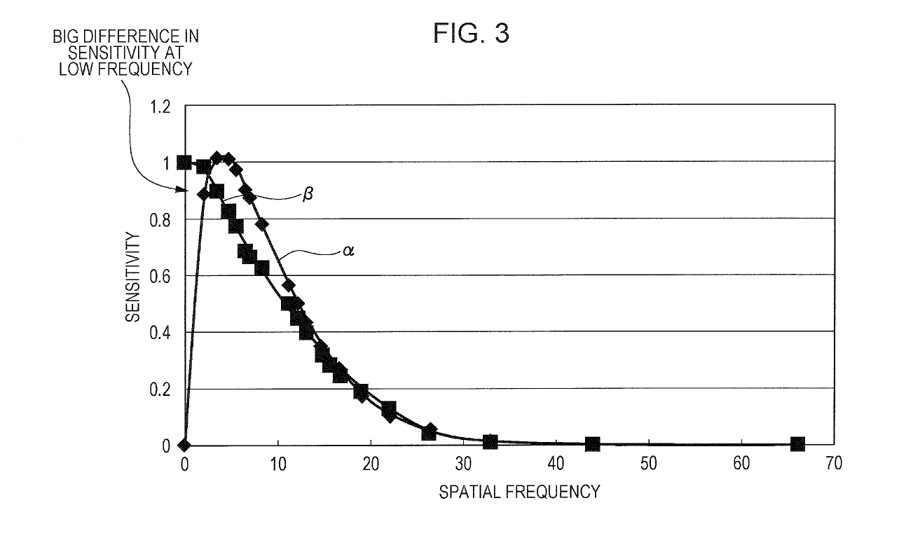

FIG. 3 is a diagram for explaining a visual characteristic that is applied to an image evaluation apparatus according to the present embodiment.

As illustrated in FIG. 2A, in a related-art image evaluation apparatus, CSF is subjected to frequency characteristic correction using only a function obtained by a contrast detection limit CLM, which is a visible limit of black-and-white stripes. That is to say, in a related-art image evaluation apparatus, a spatial frequency characteristic of a visual system is obtained using a limit value CLM of contrast as sensitivity.

However, in reality, although noise contrast in a noise image has much higher than contrast at a detection limit, a visual characteristic curve (function) obtained from a detection limit CLM of contrast having a different condition is applied.

Further, although visual characteristics have dependency on contrast as illustrated in FIG. 2B, and there are a plurality of visual characteristics, in a related-art image evaluation apparatus, only one visual characteristic curve (function) is applied as illustrated in FIG. 2C.

Accordingly, it is difficult to perform evaluation using optimum visual characteristics in a related-art image evaluation apparatus. And thus it is difficult to perform image quality evaluation that matches subjective evaluation by a human visual sense correctly with high reliability.

On the other hand, in the present image evaluation apparatus 50, in consideration that noise image does not have a contrast of a detection limit level, a sensitivity function for the case of having a certain degree of contrast is provided and applied rather than a function (CSF) in accordance with the sensitivity of the contrast detection limit CLM.

That is to say, as illustrated in FIG. 2B, in the present image evaluation apparatus 50, spatial frequency characteristics of a visual system are obtained using intensities at which contrast stripes are visible as sensitivities.

In accordance with this, as illustrated in FIG. 3, in the present image evaluation apparatus 50, a plurality of (two in the example in FIG. 3) visual characteristic curves are applied.

Thereby, in the image evaluation apparatus 50 according to the present embodiment, it is possible to perform evaluation using optimum visual characteristics. And thus it is possible to perform image quality evaluation that matches subjective evaluation by a human visual sense correctly with high reliability.

In this regard, in FIG. 3, a visual characteristic curve (function) denoted by α is selected if it is determined that contrast is low, and a visual characteristic curve (function) denoted by β is selected if it is determined that contrast is high.

In the example in FIG. 3, a case of using only two visual characteristics is illustrated. However, it is possible to apply three visual characteristic curves or more.

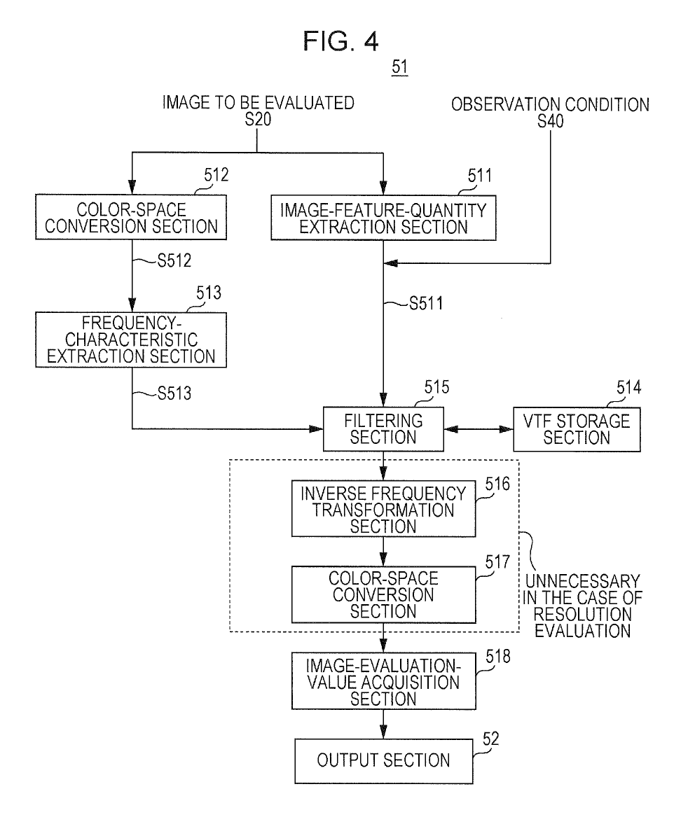

FIG. 4 is a block diagram illustrating an example of a configuration of an image-evaluation-value processing section of the image evaluation apparatus according to the present embodiment.

The image-quality evaluation value processing section 51 in FIG. 4 includes an image-feature-quantity extraction section 511, a color-space conversion section 512, a frequency-characteristic extraction section 513, a VTF storage section 514 as a holding section, and a filtering section 515 as a selection and correction section.

The image-quality evaluation value processing section 51 includes an inverse frequency transformation section 516, a color-space conversion section 517, and an image-quality-evaluation-value acquisition section 518.

The image-feature-quantity extraction section 511 extracts an image feature quantity, for example, a contrast, of the image to be evaluated S20, which is supplied from the image input device 20.

The image-feature-quantity extraction section 511 automatically calculates the image feature quantity from the image to be evaluated S20.

The image feature quantity is obtained as a standard deviation, a DR (maximum value−minimum value), a DR calculated from a histogram, a power spectrum having been subjected to frequency transformation, etc.

The color-space conversion section 512 performs normal color-space conversion processing on the image to be evaluated S20 supplied from the image input device 20, and outputs image information S512 after the color-space conversion processing to the frequency-characteristic extraction section 513.

The frequency-characteristic extraction section 513 performs, for example, FFT (Fast Fourier Transform) on the image information S512 to extract spatial frequency distribution information, which is a frequency characteristic of the image to be evaluated, and outputs extracted frequency characteristic information S513 to the filtering section 515.

If the image to be evaluated S20 is, for example, an 1S012233 chart, a start chart, a dead leaves chart, etc., the frequency-characteristic extraction section 513 extracts a spatial frequency characteristic MTF (Modulation Transfer Function).

The VTF storage section 514 stores a plurality of visual characteristic functions in advance.

The plurality of visual characteristic functions are given as functions for spatial frequency characteristics and sensitivities in advance.

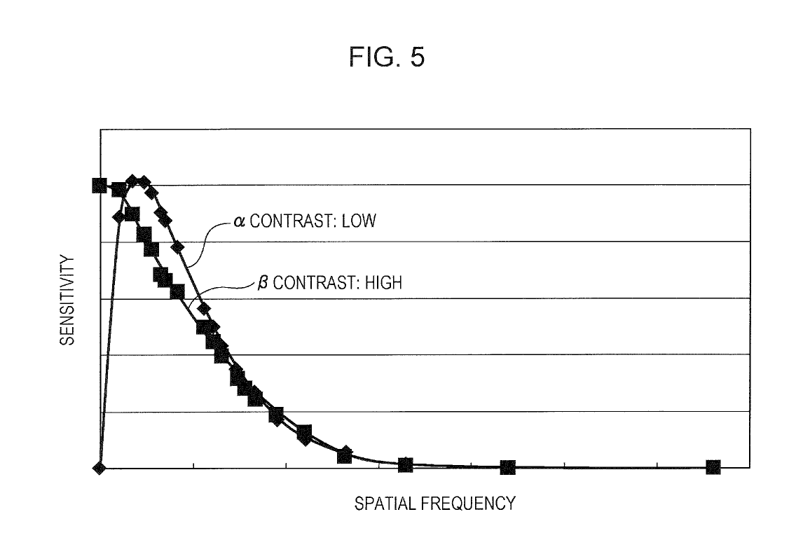

FIG. 5 is a diagram illustrating visual spatial frequency characteristics with respect to contrast.

In FIG. 5, the horizontal axis represents spatial frequency, and the vertical axis represents relative sensitivity.

In the same manner as FIG. 3, in FIG. 5, a visual characteristic curve (function) denoted by α is selected if it is determined that contrast is low, and a visual characteristic curve (function) denoted by β is selected if it is determined that contrast is high.

In the present embodiment, an optimum visual characteristic function to be used is determined by the image feature quantity extracted by the image-feature-quantity extraction section 511.

For example, an optimum function is selected from a plurality of visual characteristic functions that are stored in the storage section 514 in advance, as illustrated in FIG. 5, depending on an amplitude based on values of standard deviation, DR, etc.

The functions illustrated in FIG. 5 and FIG. 3 are expressed by the following Expression 1.

CSF(λ)=a×Exp(−bλ)×(c−Exp(−dλ)) (1)

For example, in the case of low contrast function (a), a=5.05, b=0.138, c=1.00, and d=0.10.

In the case of high contrast function (β) 4.4<a<5.2, 0.1<b<0.2, 1.2<c<1.3, and 0.3<d<0.6.

Here, λ denotes a retinal spatial frequency, and its unit is cycle/degree.

In the present embodiment, a relationship between an amplitude value and a function is determined as a fixed value in advance.

Also, it is possible to obtain the function by interpolating two near functions from an image feature quantity.

Further, as another method, it is possible to select an optimum function to be used for each frequency component on the basis of a power value of a result of frequency analysis on the image to be evaluated S20.

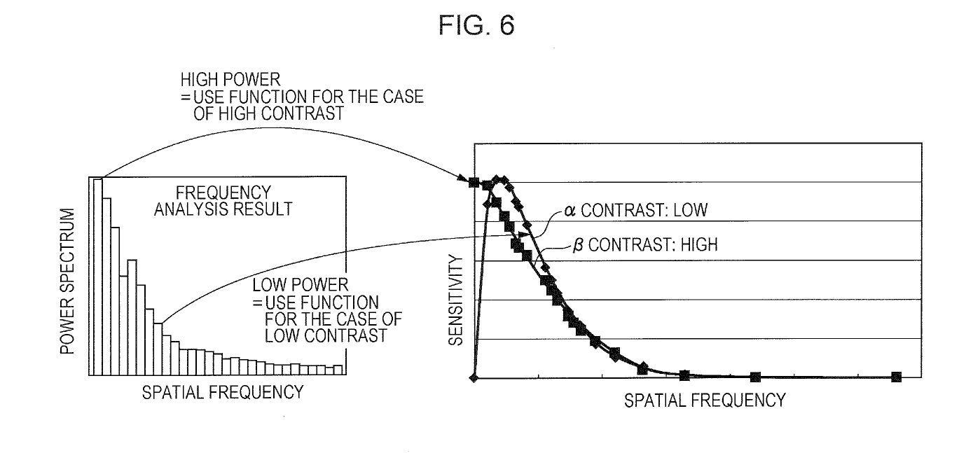

FIG. 6 is a diagram for explaining a method of determining an optimum visual characteristic from a power spectrum having been subjected to frequency transformation.

In this case, as illustrated in FIG. 6, if power is large, the function β for the case of high contrast is selected.

If power is small, the function α for the case of low contrast is selected.

The selection of an optimum visual characteristic function is made by, for example, comparison between an image feature quantity and a threshold value X. A detailed description will be further given of the method of selecting the optimum visual characteristic function later.

The filtering section 515 functions as a selection section that selects a visual characteristic function in accordance with the image feature quantity S511 extracted by the image-feature-quantity extraction section 511. And the filtering section 515 reads the selected visual characteristic function from the storage section 514, and functions as a correction section that corrects the frequency characteristic extracted by the frequency-characteristic extraction section 513 using the selected visual characteristic function.

The filtering section 515 performs correction, for example, by multiplying the selected visual characteristic function and the frequency characteristic extracted by the frequency-characteristic extraction section 513.

The inverse frequency transformation section 516 performs inverse FFT on the output signal that has been corrected by the filtering section 515. Then, for example, if an image to be evaluated is a noise image, inverse frequency transformation section 516 generates noise image on which numeric values of noise appearances are reflected, and outputs the noise image to the color-space conversion section 517.

The color-space conversion section 517 performs normal and uniform color conversion (L*, u*, v*) on noise image S517 generated by the inverse frequency transformation section 516, and output a result thereof to the image-quality-evaluation-value calculation section 518.

The image-quality-evaluation-value acquisition section 518 calculates an image-quality (image) evaluation value on the basis of image information supplied from the color-space conversion section 517 or image frequency characteristic information directly supplied from the filtering section 515.

For example, calculation, such as (σL*+0.85 σu**0.3 σv*) is performed on the basis of information by the color-space conversion section 517 so that a noise evaluation value is calculated.

The image quality evaluation value calculated by the image-quality-evaluation-value acquisition section 518 is output from the output section 52.

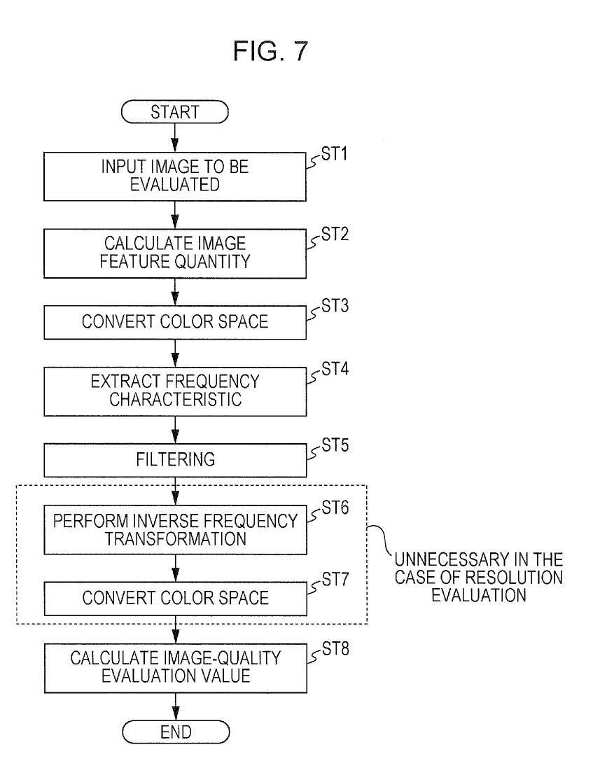

FIG. 7 is a flowchart illustrating a series of operation of the image evaluation apparatus according to the present embodiment.

In step ST1, the image evaluation apparatus 50 receives input of an image to be evaluated from the image input device 20.

In step ST2, the image-feature-quantity extraction section 511 extracts an image feature quantity, for example, contrast of the image to be evaluated S20 supplied from the image input device 20, and outputs the image feature quantity to the filtering section 515. The other image feature quantities include a background color, etc.

Also, in step ST3, the color-space conversion section 512 performs normal color-space conversion processing on the image to be evaluated S20 supplied from the image input device 20, and outputs the image information S512 after having been subjected to the color-space conversion processing to the frequency-characteristic extraction section 513.

And in step ST4, the frequency-characteristic extraction section 513 performs FFT on, for example, the image information S512, extracts spatial frequency distribution information, which is a frequency characteristic of the image to be evaluated, and outputs the extracted frequency characteristic information S513 to the filtering section 515.

In step ST5, the filtering section 515 selects a visual characteristic function in accordance with the image feature quantity S511 extracted by the image-feature-quantity extraction section 511.

And the filtering section 515 reads the selected visual characteristic function from the storage section 514, and performs correction (filtering) on the frequency characteristic extracted by the frequency-characteristic extraction section 513 using the selected visual characteristic function.

Next, in step ST6, the inverse frequency transformation section 516 performs inverse FFT on an output signal that has been corrected by the filtering section 515. For example, if an image to be evaluated is a noise image, a noise image having numeric values on which noise appearances are reflected is generated. The noise image is output to the color-space conversion section 517.

In step ST7, the color-space conversion section 517 performs normal and uniform color conversion (L*, u*, v*) on the noise image 5517 produced by the inverse frequency transformation section 516. And a result thereof is output to the image-quality-evaluation-value acquisition section 518.

And in step ST8, the image-quality-evaluation-value acquisition section 518 calculates an image-quality (image) evaluation value on the basis of the image information supplied from the color-space conversion section 517 or image-frequency characteristic information directly supplied from the filtering section 515.

The image quality evaluation value calculated by the image-quality-evaluation-value acquisition section 518 is output from the output section 52.

The image evaluation system 10 having such a configuration, according to the present embodiment, is capable of being applied to noise evaluation (Visual Noise), resolution evaluation, color reproducibility evaluation (S-CIELAB), etc., as image evaluation.

That is to say, the image evaluation system 10 according to the present embodiment is capable of being applied to an application using a visual characteristic (a relationship between spatial frequency and sensitivity), such as resolution evaluation, color reproducibility evaluation, etc., in addition to noise evaluation.

In the case of performing noise evaluation, all of the processing in steps ST1 to ST8 in FIG. 7 is performed. However, for example, in the case of resolution evaluation, a resolution index value can be obtained from the frequency characteristic after correction, and thus inverse frequency transformation in step ST6 and color space conversion in step ST7 become unnecessary.

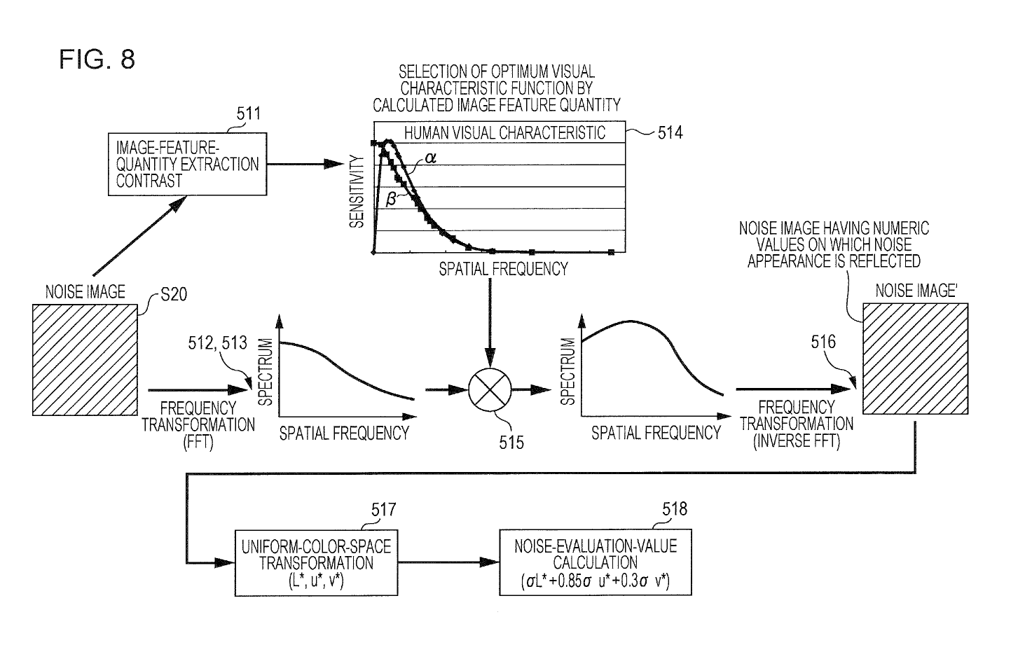

FIG. 8 is a diagram schematically illustrating an image evaluation system according to the present embodiment in the case of performing noise evaluation.

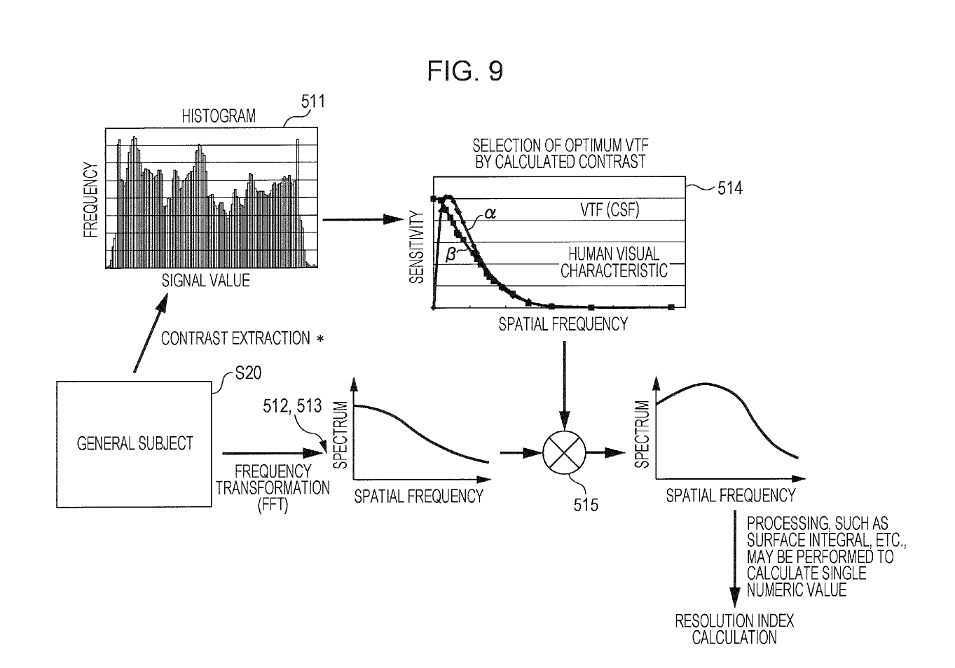

FIG. 9 is a first diagram illustrating an image evaluation system in the case of performing resolution evaluation.

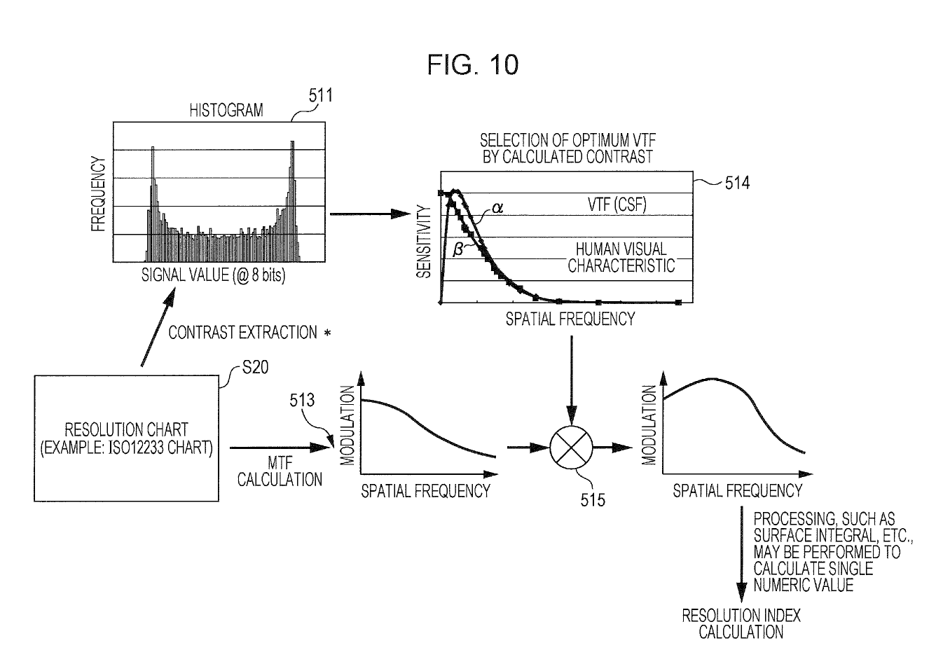

FIG. 10 is a second diagram illustrating an image evaluation system in the case of performing resolution evaluation.

In the image evaluation system that performs the noise evaluation in FIG. 8, same processing as described above is performed.

In the resolution evaluation in FIG. 9, FFT is performed on an image to be evaluated in the same manner as the case of the noise evaluation in FIG. 8.

In the resolution evaluation in FIG. 10, an ISO12233 chart, or a start chart, etc., is used as the image to be evaluated S20, and a spatial frequency characteristic MTF is extracted.

In the case of the resolution evaluation in FIG. 9 and FIG. 10, examples in which contrast calculation is obtained from a histogram are illustrated, and a difference between a maximum and a minimum of an image may be simply used as a contrast.

Also, at the time of calculating a resolution index, processing, such as surface integral, etc., may be performed so as to calculate a single numeric value.

3. Method of Selecting a Visual Characteristic Function by Threshold Value

3.1 Expression of Visual Characteristic Function (Experimental Value)

Although a duplicate description will be given, the function illustrated in FIG. 5 is expressed by the following Expression 1.

VTF(λ)=a×Exp(−bλ)×(c−Exp(−dλ)) (1)

For example, in the case of low contrast function (a), a=5.05, b=0.138, c=1.00, and d=0.10.

In the case of high contrast function (β), 4.4<a<5.2, 0.1<b<0.2, 1.2<c<1.3, and 0.3<d<0.6.

Here, k denotes a retinal spatial frequency, and its unit is cycle/degree.

3.2 First Selection Method of Visual Characteristic Function by Threshold Value

In the present embodiment, two functions are selected for the sake of simplicity. However, it is possible to handle the case of having two functions or more.

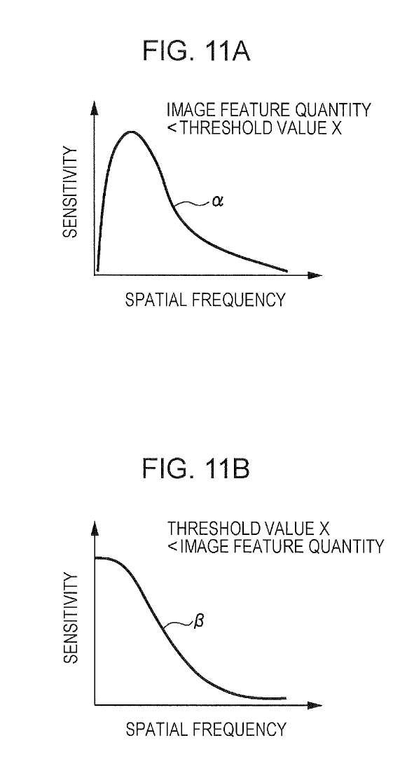

FIGS. 11A and 11B are diagrams illustrating an example in which a visual characteristic function illustrated in FIG. 5 is selected by comparing a threshold value and an image feature quantity.

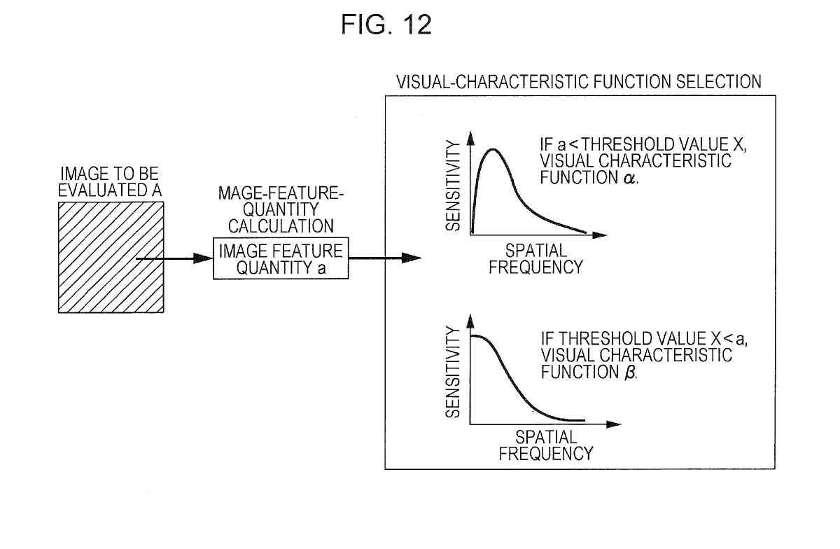

FIG. 12 is a diagram for explaining a first selection method of selecting a visual characteristic function illustrated in FIG. 5 by comparing a threshold value and an image feature quantity.

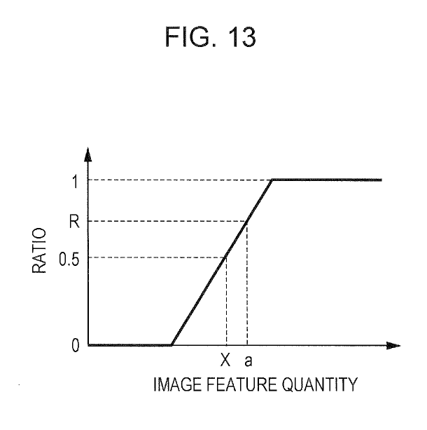

FIG. 13 is a diagram illustrating a ratio calculation graph for generating a visual characteristic function.

As illustrated in FIGS. 11A and 11B, a visual characteristic function to be selected is determined by an image feature quantity a calculated from an image to be evaluated and a threshold value X determined in advance.

As illustrated in FIG. 12, in the selection of a visual characteristic function, first, an image feature quantity a is calculated from an input image.

Next, in order to select a visual characteristic function to be used, a comparison is made between the image feature quantity a and the threshold value X. If a<X, a function α is selected, and else if X<a, a function β is selected.

Also, as another method, there is a method of generating a visual characteristic function from a function graph held in advance.

The method of generation includes a method of adding two functions multiplied by weights, respectively. The weights can be obtained from an image feature quantity a of the input image in a form illustrated in FIG. 13.

The generation is carried out by the following expression.

f₃=(1−R)×f₁+R×f₂ (2)

Here, f₃ denotes a generated visual characteristic function, f₁ denotes a visual characteristic function α, and f₂ denotes a visual characteristic function β.

3.2 Second Selection Method of Visual Characteristic Function by Threshold Value

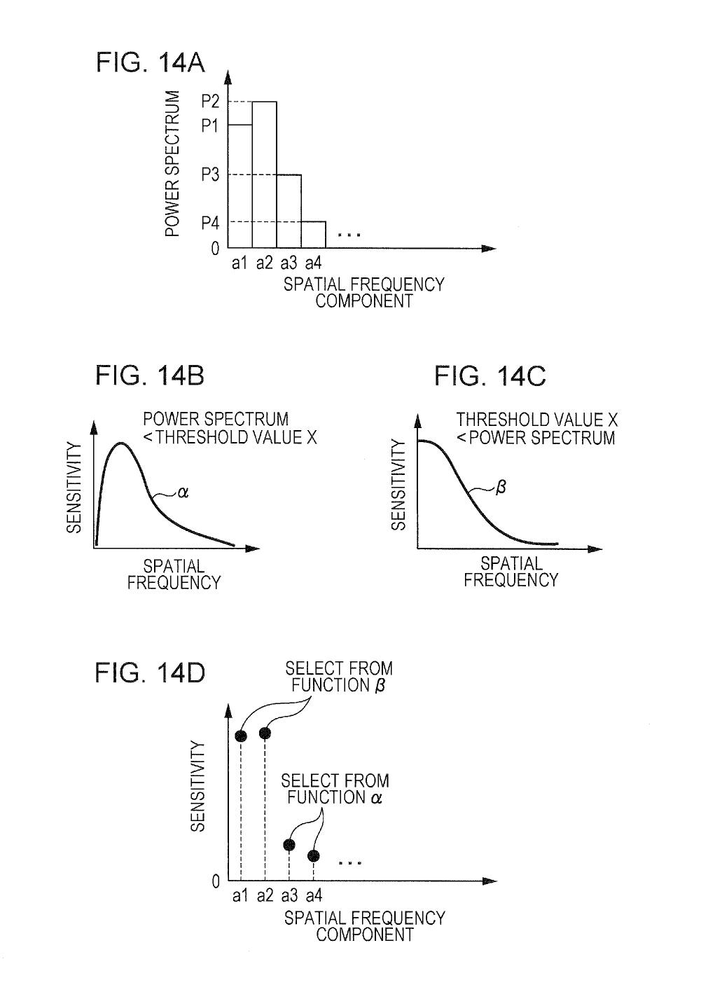

FIGS. 14A, 14B, 14C, and 14D are diagrams for specifically explaining a method of generating an optimum function for each frequency component, illustrated in FIG. 6.

Next, a specific description will be given of a second selection method of generating an optimum function for each frequency component illustrated in FIG. 6.

First, frequency analysis is performed on an image to be evaluated.

A comparison is made between a power spectrum P1 of a frequency component a1 obtained by that and a threshold value X.

Here, X<P1, and thus sensitivity at the time of frequency component a1 is obtained by the function β. Next, in the same manner, a comparison is made between a power spectrum P2 of a frequency component a2 and the threshold value X, and sensitivity at time of a2 is obtained.

This processing is performed for all the frequency components so that an optimum function is generated.

Here, a description has been given of a method of obtaining by either one of the functions. In place of the image feature quantity in FIG. 13, a power spectrum is used so that it is possible to obtain sensitivity from the ratio of the two functions.

3.3 Third Selection Method of Visual Characteristic Function by Threshold Value

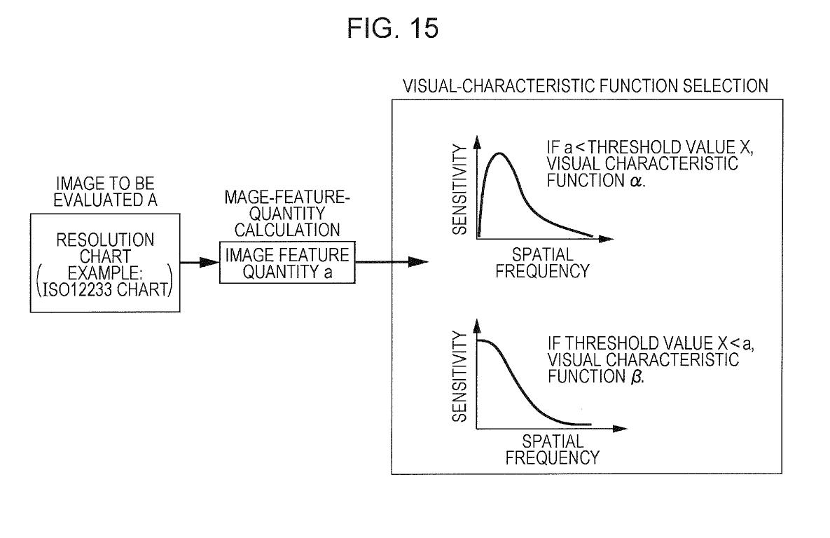

FIG. 15 is a diagram illustrating an example in which the visual characteristic function in the resolution evaluation using the chart in FIG. 10 is selected by comparing a threshold value and an image feature quantity.

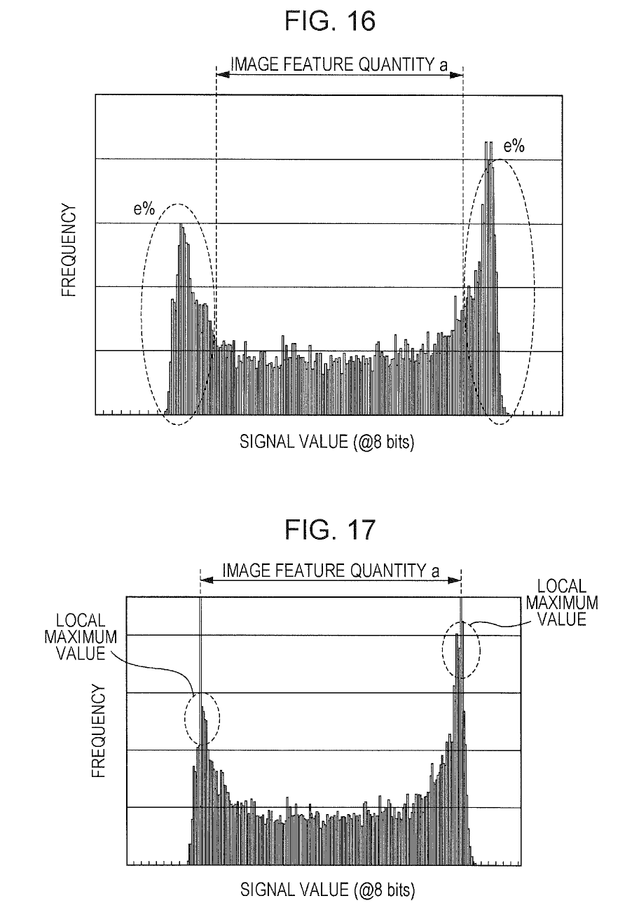

FIG. 16 is a first method of determining a range of an image feature quantity from the histogram of the image to be evaluated in FIG. 15.

FIG. 17 is a second method of determining a range of an image feature quantity from the histogram of the image to be evaluated in FIG. 15.

In this case, two functions are used for the sake of simplicity in the same manner as the first selection method. However, it is possible to handle the case of having two functions or more.

And as illustrated in FIGS. 11A and 11B, a visual characteristic function to be selected is determined by an image feature quantity calculated from the image to be evaluated and a threshold value X determined in advance.

In the selection of a visual characteristic function, as illustrated in FIG. 15, first, an image feature quantity a is calculated from an input image.

As illustrated in FIG. 16, the image feature quantity a is determined, for example, to be a range produced by removing e % of all the frequencies (100%) from a maximum signal value and a minimum signal value in a histogram calculated from an image A.

Alternatively, as illustrated in FIG. 17, the image feature quantity a may be determined to be a difference of signal values at local maximum values closest to a maximum signal value and a minimum signal value, respectively.

Alternatively, a difference between a maximum signal value and a minimum signal value in an image may be simply determined to be a.

Next, in order to select a visual characteristic function to be used, a comparison is made between the image feature quantity a and the threshold value X. If a<X, a function α is selected, and else if X<a, a function β is selected.

Also, as another method, there is a method of generating a visual characteristic function from a function graph held in advance. The method of generation includes a method of adding two functions multiplied by weights, respectively. The weights can be obtained from an image feature quantity of an input image in a form illustrated in FIG. 13.

The generation is carried out by Expression 2 described above.

As described above, by the present embodiment, the image evaluation apparatus 50 selects a visual characteristic function in accordance with the image feature quantity extracted from a plurality of visual characteristic functions that are given in advance. And, the image evaluation apparatus 50 corrects the frequency characteristic extracted by the selected visual characteristic function, and an image evaluation value is obtained on the basis of the corrected frequency characteristic information.

Accordingly, it is possible to perform evaluation using optimum visual characteristics, and it becomes possible to perform image quality evaluation that matches subjective evaluation by a human visual sense correctly with high reliability.

In this regard, it is possible to configure the method described above in detail as a program in accordance with the above-described procedure, and to execute the program on a computer, such as a CPU, etc.

Also, it is possible to store such a program into a recording medium, such as a semiconductor memory, a magnetic disk, an optical disc, a floppy (registered trademark) disk, etc., and to execute the program on a computer to which the recording medium is set.

In this regard, this technique can be configured as follows.

(1) An image evaluation apparatus including:

a holding section configured to hold a plurality of visual characteristic functions in advance;

an image-feature-quantity extraction section configured to extract an image feature quantity of an image to be evaluated;

a frequency-characteristic extraction section configured to extract a frequency characteristic of the image to be evaluated;

a selection section configured to select a visual characteristic function in accordance with the image feature quantity extracted by the image-feature-quantity extraction section from the plurality of visual characteristic functions of the holding section;

a correction section configured to correct the frequency characteristic extracted by the frequency-characteristic extraction section using the visual characteristic function selected by the selection section; and

an image-evaluation-value acquisition section configured to acquire an image evaluation value on the basis of frequency characteristic information corrected by the correction section.

(2) The image evaluation apparatus according to (1),

wherein the image-feature-quantity extraction section extracts a contrast of the image to be evaluated as the image feature quantity, and

the plurality of visual characteristic functions held by the holding section include a function for a case where a contrast other than a function corresponding to a limit value of the contrast is provided in a spatial frequency characteristics in a visual system.

(3) The image evaluation apparatus according to (2),

wherein the selection section compares the image feature quantity extracted and a threshold value set in advance,

if the image feature quantity is less than the threshold value, the selection section selects a visual characteristic function of a lower contrast side, and

if the image feature quantity is greater than the threshold value, the selection section selects a visual characteristic function of a higher contrast side.

(4) The image evaluation apparatus according to (1),

wherein the image-feature-quantity extraction section extracts a power spectrum by frequency analysis of the image to be evaluated as the image feature quantity, and

the plurality of visual characteristic functions held by the holding section include a function for a case where a contrast other than a function corresponding to a limit value of the contrast is provided in a spatial frequency characteristics in a visual system.

(5) The image evaluation apparatus according to (4),

wherein the selection section compares the image feature quantity extracted for each frequency component and a threshold value set in advance,

if the image feature quantity is less than the threshold value, the selection section selects a visual characteristic function of a lower contrast side, and

if the image feature quantity is greater than the threshold value, the selection section selects a visual characteristic function of a higher contrast side.

(6) The image evaluation apparatus according to any one of (1) to (5),

wherein the visual characteristic function is obtained by interpolating two functions closer than the image feature quantity.

(7) The image evaluation apparatus according to any one of (1) to (6), further including a frequency transformation section configured to perform frequency transformation on output information of the correction section,

wherein the image to be evaluated is a noise image including noise for performing noise evaluation,

the frequency-characteristic extraction section performs frequency transformation on the image to be evaluated to extract spatial frequency distribution information being a frequency characteristic of the image to be evaluated, and

the frequency transformation section generates a noise image including numeric values on which noise appearance is reflected, and outputs information on the generated noise image to the image-evaluation-value acquisition section.

(8) The image evaluation apparatus according to any one of (1) to (6),

wherein the image to be evaluated is an image for performing resolution evaluation, and

the frequency-characteristic extraction section performs frequency transformation on the image to be evaluated to extract spatial frequency distribution information being a frequency characteristic of the image to be evaluated.

(9) The image evaluation apparatus according to any one of (1) to (6),

wherein the image to be evaluated is a chart image for performing resolution evaluation, and

the frequency-characteristic extraction section extracts a spatial frequency characteristic (MTF) of the image to be evaluated.

(10) A method of evaluating an image, the method including:

extracting an image feature quantity of an image to be evaluated;

extracting a frequency characteristic of the image to be evaluated;

selecting a visual characteristic function in accordance with the image feature quantity extracted by the extracting an image feature quantity from a plurality of visual characteristic functions given in advance;

correcting the frequency characteristic extracted by the extracting a frequency characteristic using the visual characteristic function selected by the selecting; and

acquiring an image evaluation value on the basis of frequency characteristic information corrected by the correcting.

(11) The method of evaluating an image according to (10),

wherein the extracting an image feature quantity of an image to be evaluated extracts a contrast of the image to be evaluated as the image feature quantity, and

the plurality of visual characteristic functions held by the holding section include a function for a case where a contrast other than a function corresponding to a limit value of the contrast is provided in a spatial frequency characteristics in a visual system.

(12) The method of evaluating an image according to

wherein the selecting compares the image feature quantity extracted and a threshold value set in advance,

if the image feature quantity is less than the threshold value, the selecting selects a visual characteristic function of a lower contrast side, and

if the image feature quantity is greater than the threshold value, the selection section selects a visual characteristic function of a higher contrast side.

(13) The method of evaluating an image according to (10),

wherein the extracting an image feature quantity extracts a power spectrum by frequency analysis of the image to be evaluated as the image feature quantity, and

the plurality of visual characteristic functions held by the holding section include a function for a case where a contrast other than a function corresponding to a limit value of the contrast is provided in a spatial frequency characteristics in a visual system.

(14) The method of evaluating an image according to (13),

wherein the selecting compares the image feature quantity extracted for each frequency component and a threshold value set in advance,

if the image feature quantity is less than the threshold value, the selection section selects a visual characteristic function of a lower contrast side, and

if the image feature quantity is greater than the threshold value, the selection section selects a visual characteristic function of a higher contrast side.

(15) The method of evaluating an image according to any one of (10) to (14),

wherein the visual characteristic function is obtained by interpolating two functions closer than the image feature quantity.

(16) A program for causing a computer to perform image evaluation processing including:

extracting an image feature quantity of an image to be evaluated;

extracting a frequency characteristic of the image to be evaluated;

selecting a visual characteristic function in accordance with the image feature quantity extracted by the extracting an image feature quantity from a plurality of visual characteristic functions given in advance;

correcting the frequency characteristic extracted by the extracting a frequency characteristic using the visual characteristic function selected by the selecting; and

acquiring an image evaluation value on the basis of frequency characteristic information corrected by the correcting.

The present disclosure contains subject matter related to that disclosed in Japanese Priority Patent Application JP 2011-237851 filed in the Japan Patent Office on Oct. 28, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image evaluation apparatus comprising:
a holding section configured to hold a plurality of visual characteristic functions in advance;
an image-feature-quantity extraction section configured to extract an image feature quantity of an image to be evaluated;
a frequency-characteristic extraction section configured to extract a frequency characteristic of the image to be evaluated;
a selection section configured to select a visual characteristic function in accordance with the image feature quantity extracted by the image-feature-quantity extraction section from the plurality of visual characteristic functions of the holding section;
a correction section configured to correct the frequency characteristic extracted by the frequency-characteristic extraction section using the visual characteristic function selected by the selection section; and
an image-evaluation-value acquisition section configured to acquire an image evaluation value on the basis of frequency characteristic information corrected by the correction section.

2. The image evaluation apparatus according to claim 1,
wherein the image-feature-quantity extraction section extracts a contrast of the image to be evaluated as the image feature quantity, and
the plurality of visual characteristic functions held by the holding section include a function for a case where a contrast other than a function corresponding to a limit value of the contrast is provided in a spatial frequency characteristics in a visual system.

3. The image evaluation apparatus according to claim 2,
wherein the selection section compares the image feature quantity extracted and a threshold value set in advance,
if the image feature quantity is less than the threshold value, the selection section selects a visual characteristic function of a lower contrast side, and
if the image feature quantity is greater than the threshold value, the selection section selects a visual characteristic function of a higher contrast side.

4. The image evaluation apparatus according to claim 1,
wherein the image-feature-quantity extraction section extracts a power spectrum by frequency analysis of the image to be evaluated as the image feature quantity, and
the plurality of visual characteristic functions held by the holding section include a function for a case where a contrast other than a function corresponding to a limit value of the contrast is provided in a spatial frequency characteristics in a visual system.

5. The image evaluation apparatus according to claim 4,
wherein the selection section compares the image feature quantity extracted for each frequency component and a threshold value set in advance,
if the image feature quantity is less than the threshold value, the selection section selects a visual characteristic function of a lower contrast side, and
if the image feature quantity is greater than the threshold value, the selection section selects a visual characteristic function of a higher contrast side.

6. The image evaluation apparatus according to claim 1,
wherein the visual characteristic function is obtained by interpolating two functions closer than the image feature quantity.

7. The image evaluation apparatus according to claim 1, further comprising a frequency transformation section configured to perform frequency transformation on output information of the correction section,
wherein the image to be evaluated is a noise image including noise for performing noise evaluation,
the frequency-characteristic extraction section performs frequency transformation on the image to be evaluated to extract spatial frequency distribution information being a frequency characteristic of the image to be evaluated, and
the frequency transformation section generates a noise image including numeric values on which noise appearance is reflected, and outputs information on the generated noise image to the image-evaluation-value acquisition section.

8. The image evaluation apparatus according to claim 1,
wherein the image to be evaluated is an image for performing resolution evaluation, and
the frequency-characteristic extraction section performs frequency transformation on the image to be evaluated to extract spatial frequency distribution information being a frequency characteristic of the image to be evaluated.

9. The image evaluation apparatus according to claim 1,
wherein the image to be evaluated is a chart image for performing resolution evaluation, and
the frequency-characteristic extraction section extracts a spatial frequency characteristic (MTF) of the image to be evaluated.

10. A method of evaluating an image, the method comprising:
extracting an image feature quantity of an image to be evaluated;
extracting a frequency characteristic of the image to be evaluated;
selecting a visual characteristic function in accordance with the image feature quantity extracted by the extracting an image feature quantity from a plurality of visual characteristic functions given in advance;
correcting the frequency characteristic extracted by the extracting a frequency characteristic using the visual characteristic function selected by the selecting; and
acquiring an image evaluation value on the basis of frequency characteristic information corrected by the correcting.

11. The method of evaluating an image according to claim 10,
wherein the extracting an image feature quantity of an image to be evaluated extracts a contrast of the image to be evaluated as the image feature quantity, and
the plurality of visual characteristic functions held by the holding section include a function for a case where a contrast other than a function corresponding to a limit value of the contrast is provided in a spatial frequency characteristics in a visual system.

12. The method of evaluating an image according to claim 11,
wherein the selecting compares the image feature quantity extracted and a threshold value set in advance,
if the image feature quantity is less than the threshold value, the selecting selects a visual characteristic function of a lower contrast side, and
if the image feature quantity is greater than the threshold value, the selection section selects a visual characteristic function of a higher contrast side.

13. The method of evaluating an image according to claim 10,
wherein the extracting an image feature quantity extracts a power spectrum by frequency analysis of the image to be evaluated as the image feature quantity, and
the plurality of visual characteristic functions held by the holding section include a function for a case where a contrast other than a function corresponding to a limit value of the contrast is provided in a spatial frequency characteristics in a visual system.

14. The method of evaluating an image according to claim 13,
wherein the selecting compares the image feature quantity extracted for each frequency component and a threshold value set in advance,
if the image feature quantity is less than the threshold value, the selection section selects a visual characteristic function of a lower contrast side, and
if the image feature quantity is greater than the threshold value, the selection section selects a visual characteristic function of a higher contrast side.

15. The method of evaluating an image according to claim 10,
wherein the visual characteristic function is obtained by interpolating two functions closer than the image feature quantity.

16. A program for causing a computer to perform image evaluation processing comprising:
extracting an image feature quantity of an image to be evaluated;
extracting a frequency characteristic of the image to be evaluated;
selecting a visual characteristic function in accordance with the image feature quantity extracted by the extracting an image feature quantity from a plurality of visual characteristic functions given in advance;
correcting the frequency characteristic extracted by the extracting a frequency characteristic using the visual characteristic function selected by the selecting; and
acquiring an image evaluation value on the basis of frequency characteristic information corrected by the correcting.
